(19) United States
(12) Patent Application Publication
(10) Pub. No.: US 2008/0126215 A1
(43) Pub. Date: May 29, 2008

(54) Bidding system and method

(76) Inventor: Nissim Orfaly, Tel Aviv (IL)

Correspondence Address: Nissim Orfaly, 3 Shmuel Tamir Street, Tel Aviv, 69637, omitted

(21) Appl. No.: 11/480,406

(22) Filed: Jul. 5, 2006

(51) Int. Cl. G06Q 30/00

(52) U.S. Cl. 705/26

(57) ABSTRACT

A bidding method for buying products over the Internet comprising: a. setting parameters for a bid; b. opening the bid; c. accepting offers in the bid, if the offers conform to predefined requirements and the parameters of the bid; d. closing the bid according to predefined requirements and the parameters of the bid; e. choosing a winner in the bid, if possible, according to the parameters of the bid. The chosen winner is the offer which is closest to an average value of all the accepted offers.

### BACKGROUND OF THE INVENTION

The present invention relates to systems and methods for buying products over the Internet using a bidding procedure. Customers desire to buy products at lower prices. Prior art systems allow to compare prices asked by various vendors, prior to reaching a decision where to buy.

There are bidding systems where the highest bid wins. This may be disadvantageous for the buyer, as the system pushes the price up, and each customer, by bidding against the others at ever increasing prices, only causes the buying price to get higher.

It may be desirable to allow a plurality of people to participate in bidding, and grant the product to other than the highest bidder.

It may be desirable to allow each participant to make an intelligent decision regarding the bid, and to influence, to some extent, the outcome of the bid.

It is an objective of the present invention to overcome the above and other disadvantages of prior art accidents prevention systems.

### BRIEF SUMMARY OF THE INVENTION

According to one aspect of the present invention, a bid method is implemented wherein the winner is not the highest offer, but the offer which is closest to the average.

As more people join the bid, each offering a different price for the product, the average value will change accordingly.

Thus, a plurality of people may participate in bidding, and the winner is not the highest bidder. Thus, the bid is more attractive, as there is a possibility to buy a product at a lower cost, and there is no pressure on the participants to ever increase the amount of the bids.

Furthermore, each participant can make an intelligent decision regarding the bid. By setting the amount of the bid, or by placing several bids at various amounts, each participant can influence, to some extent, the outcome of the bid.

According to another aspect of the present invention, the bid method proceeds in an orderly, predefined way, starting with defining the bid parameters, opening the bid, accepting offers which conform to predefined rules, closing the bid according to participation in the bid and per the bid rules, declaring the winner if there is to be a winner, and delivering the product to the winner.

Further features and advantages of the present invention will be described and detailed hereinafter.

### BRIEF DESCRIPTION OF THE SEVERAL VIEWS OF THE DRAWINGS

FIG. 1 illustrates the overall bidding method

FIG. 2 details a method for evaluating bids the stage of verifying and accepting a user's offer

FIG. 3 details a method for presenting bid parameters and results

FIG. 4 details a method for choosing the winner

FIG. 5 details the state of the bid at one instant in time

FIG. 6 details the state of the bid at another instant in time

FIG. 7 details the state of the bid as presented to a user

FIG. 8 details a method for managing the bid and presenting info to participants

FIG. 9 details a method for interfacing with participants in the bid FIG. 10 details a method for presenting the rules of the bid to participants

### DETAILED DESCRIPTION OF THE INVENTION

The present invention will now be detailed by means of example using specific embodiments and referring to the drawings.

Bidding Method

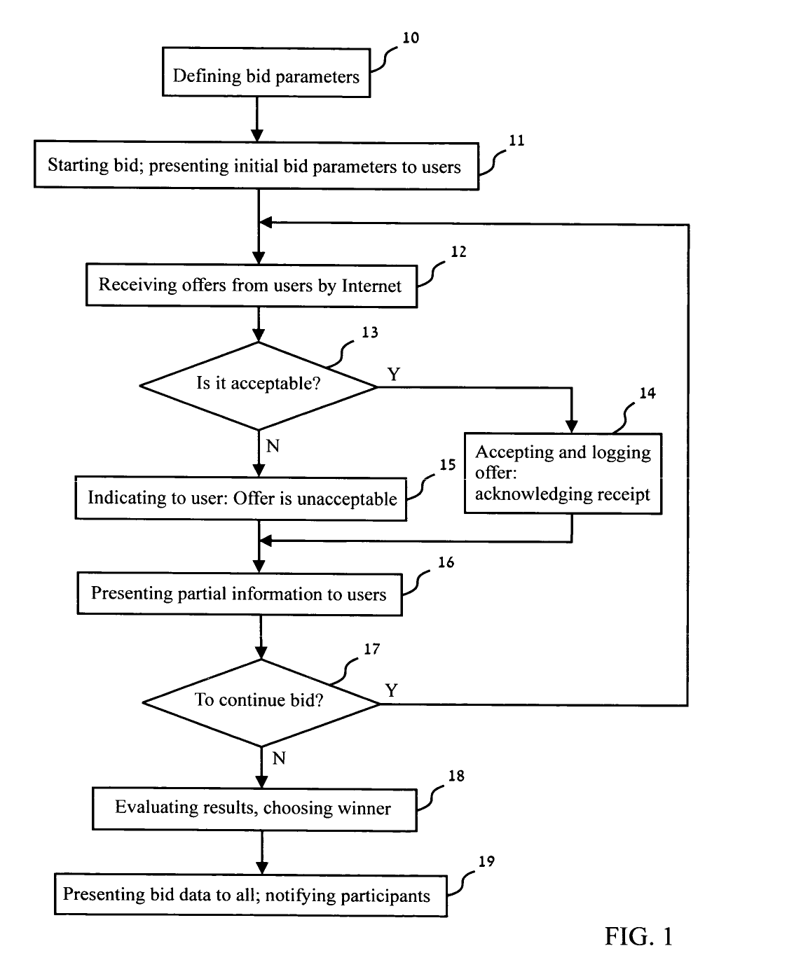

FIG. 1 illustrates the overall bidding method, including:

a. Defining the bid parameters 10

b. Starting a bid; presenting initial bid parameters to users 11

c. Receiving offers from users by Internet 12

d. For each offer, checking: Is it acceptable? 13

e. If acceptable: Accepting and logging offer; acknowledging receipt 14

f. If unacceptable, then Indicating to user: Offer is unacceptable 15

g. Presenting partial information to users 16

h. To continue bid? 17

i. After bid ended: Evaluating results, choosing winner 18

j. Presenting bid data to all; notifying participants 19

** End of method **

Bid Evaluating Method

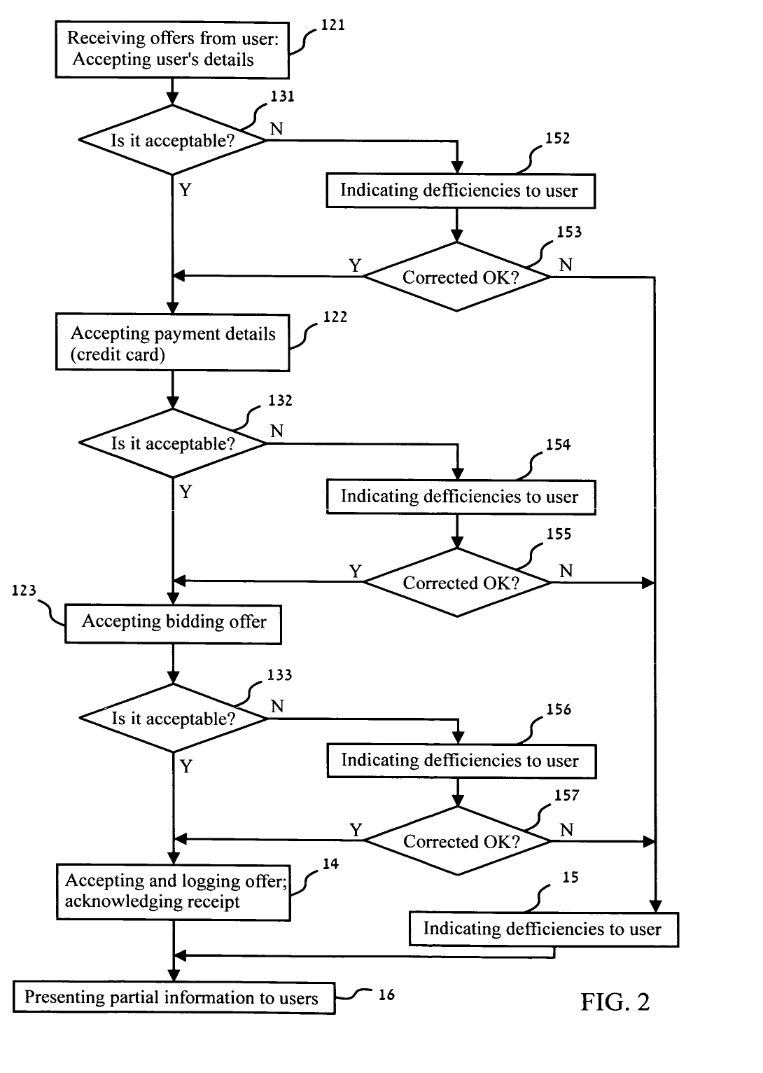

FIG. 2 details a method for evaluating bids, and the stage of verifying and accepting a user's offer, including:

a. Receiving offers from user: Accepting user's details 121

b. Checking: Is it acceptable? 131

c. If not: Indicating deficiencies to user 152

d. Corrected OK? 153

e. If yes: Accepting payment details (credit card) 122

f. Is it acceptable? 132

g. If not: Indicating deficiencies to user 154

h. Corrected OK? 155

i. If yes: Accepting bidding offer 123

j. Is it acceptable? 133

k. If not: Indicating deficiencies to user 156

l. Corrected OK? 157

m. If yes: Accepting and logging offer; acknowledging receipt 14

n. Indicating to user: Offer is unacceptable 15

p. Presenting partial information to users 16

** End of method **

Method for Managing Bid Parameters

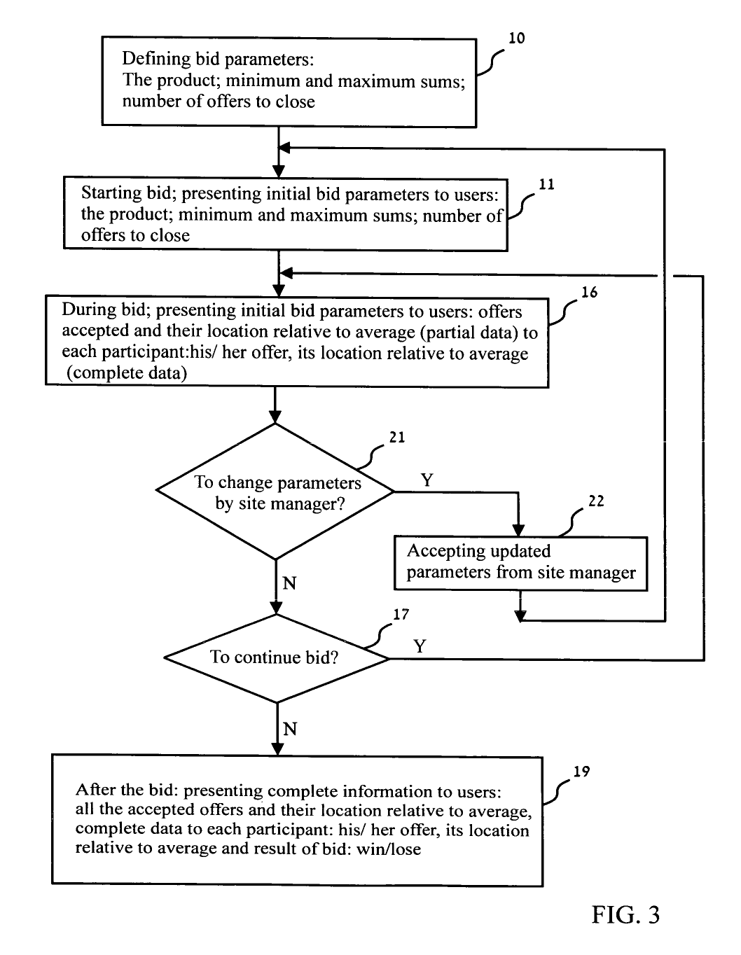

FIG. 3 details an embodiment of a method for presenting bid parameters and results the stage of setting and managing the bid parameters, as follows:

a. Defining bid parameters: 10

The product; minimum and maximum sums; number of offers to close

b. Starting bid; presenting initial bid parameters to users: 11

The product; minimum and maximum sums; number of offers to close;

c. During the bid: presenting partial information to users: 16 offers accepted and their location relative to average, but without the amounts in other's offers (partial data); to each participant: his/her offer or offers, their location relative to average and the amount of each offer (complete data).

d. To change parameters 21 by site manager?

e. If yes: Accepting updated parameters from site manager 22 Whilst the bid is open, accepting orders to change bid parameters from a site manager; checking each order according to predefined rules. If the order is accepted, notifying participants in the bid of the new parameters.

f. After the bid: presenting complete information to users: 19 all the accepted offers and their location relative to average, complete data to each participant: his/her offer, its location relative to average and result of bid: win/lose.

** End of method **

Method for Choosing the Winner

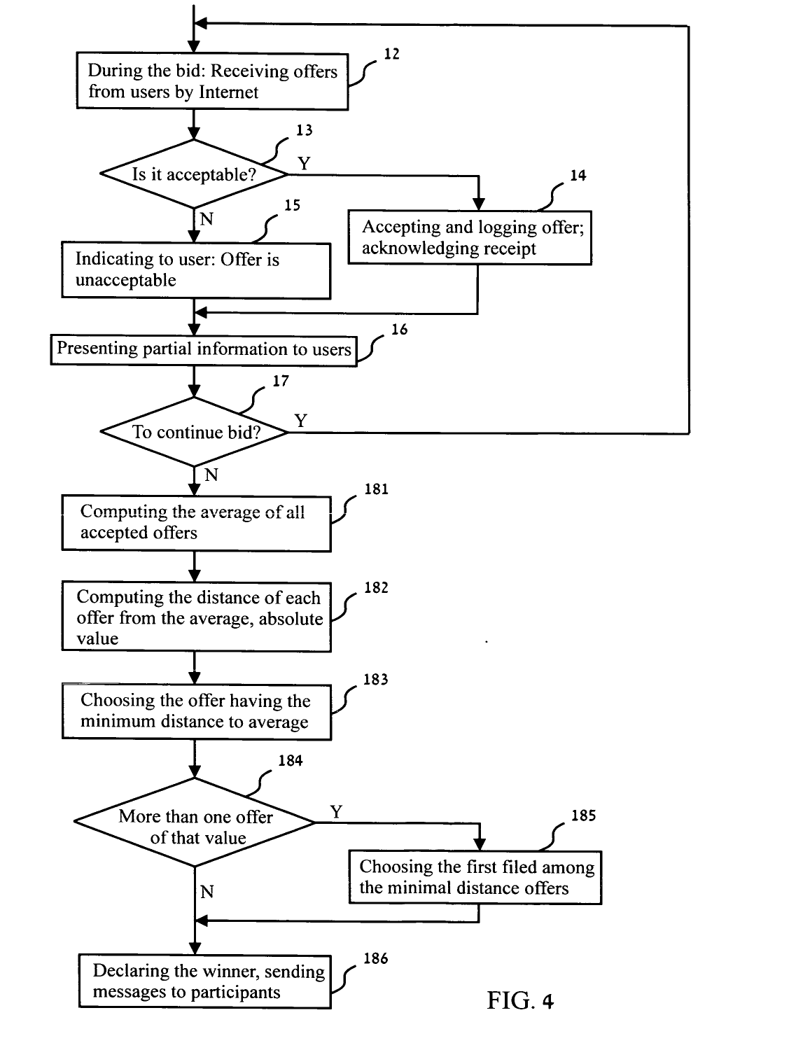

FIG. 4 details a method for choosing the winner, if possible, including the following steps:

a. During the bid: 12 Receiving offers from users by Internet

b. Is the offer acceptable? 13 The offer is checked according to a predefined algorithm

c. If yes: Accepting and logging offer; acknowledging receipt 14 Each accepted offer is logged together with the time and date of its acceptance.

d. If not, then Indicating to user: Offer is unacceptable 15

e. Presenting partial information to users 16

f. To continue bid? 17

g. If no: Computing the average of all accepted offers 181 This is the arithmetic average, that is the sum of all the accepted offers divided by the number of the offers.

h. Computing the distance of each offer from the average, absolute value 182 The calculation involves computing the difference between each offer and the average value computed in step (g) above, and then taking its absolute value (converting a negative value to positive).

i. Choosing the offer having the minimum distance to average 183 This is the offer having the lowest value of distance as computed in step (h) above.

j. More than one offer of that value? 184

k. If yes: Choosing the first filed among the minimal distance offers 185

l. Declaring the winner, sending messages to participants 186

** End of method **

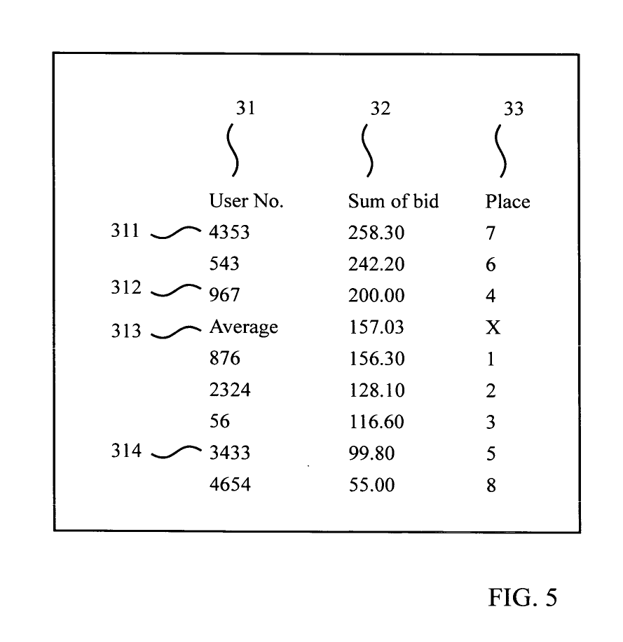

FIG. 5 details the state of the bid at one instant in time. There is a column of user numbers 31, with a corresponding column of the sum of the bid 32 for each participant. The system computes the relative place 33 - the relative distance to the Average value 313.

For example, a first user 311 (No. 4353) placed a bid for NIS 258.30. He/she is at place 7, there are 6 bidders closer to the Average than he. Another user 312, by offering a lower sum, is closer to the average (the target). Yet another user 314, by bidding too low, is still far from the average 313.

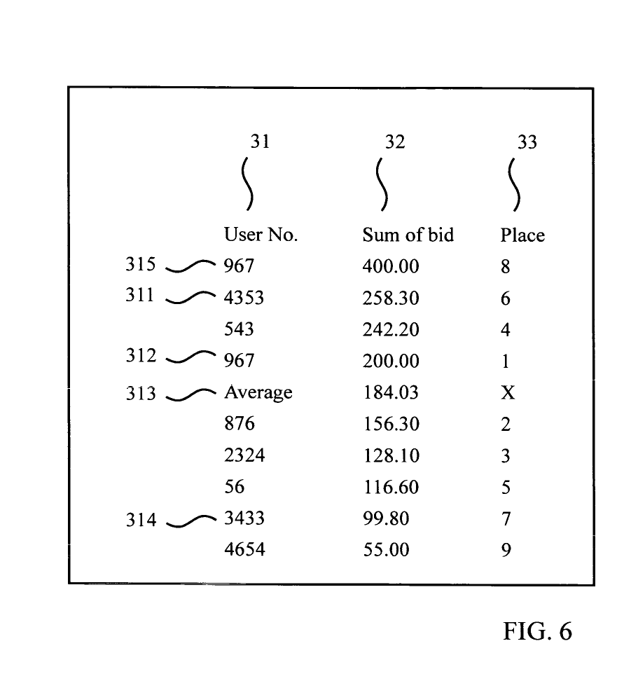

FIG. 6 details the state of the bid at another instant in time The user 315 (NO. 967) places a second offer for a large amount, thus he changes the average 313 with his offer - the average is higher. The new average is closer to his previous offer 312.

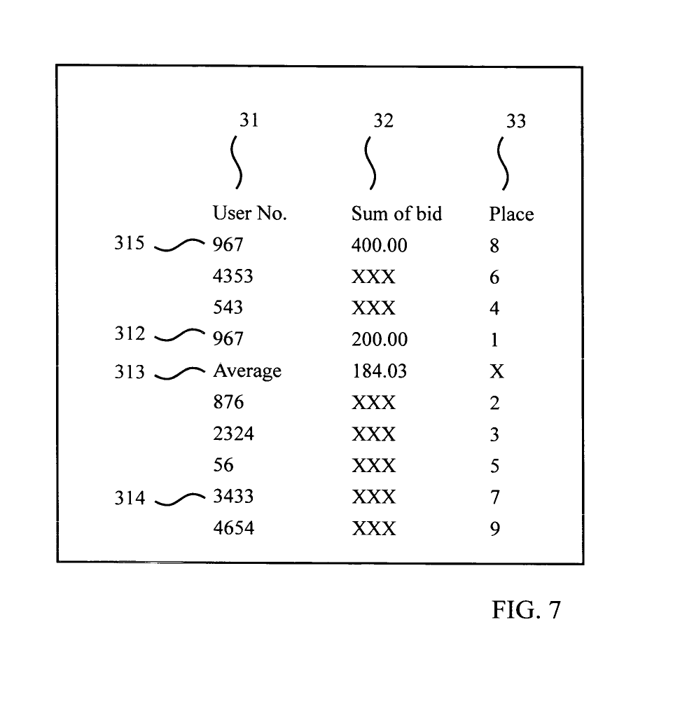

FIG. 7 details the state of the bid as presented to a user The user No. 967 can only see the details of his offers 312, 315 and the average 313. The details of the other offers are hidden from him. After the bid ends, the details of all the bids are disclosed for review of all the participants, and a display as in FIGS. 5.6 is presented to all.

Method for Managing the Bid

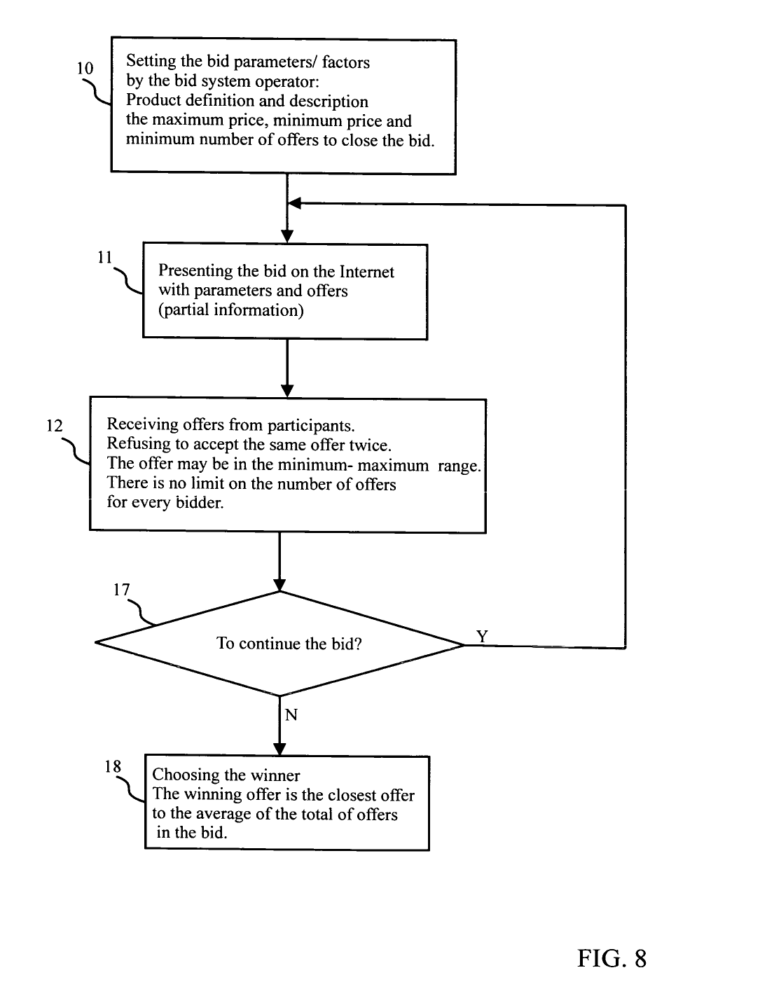

FIG. 8 details a method for managing the bid and presenting info to participants:

a. Setting the bid parameters/factors 10 by the bid system operator: Product definition and description the maximum price, minimum price and minimum number of offers to close the bid.

b. Presenting the bid on the Internet 11 with parameters and offers (partial information)

c. Receiving offers from participants. 12 Refusing to accept the same offer twice. The offer may be in the minimum-maximum range. There is no limit on the number of offers for every bidder.

d. To close the bid? 17

e. If yes: Choosing the winner 18 The winning offer is the closest offer to the average of the total of offers in the bid.

** End of method **

Method for Choosing the Winner

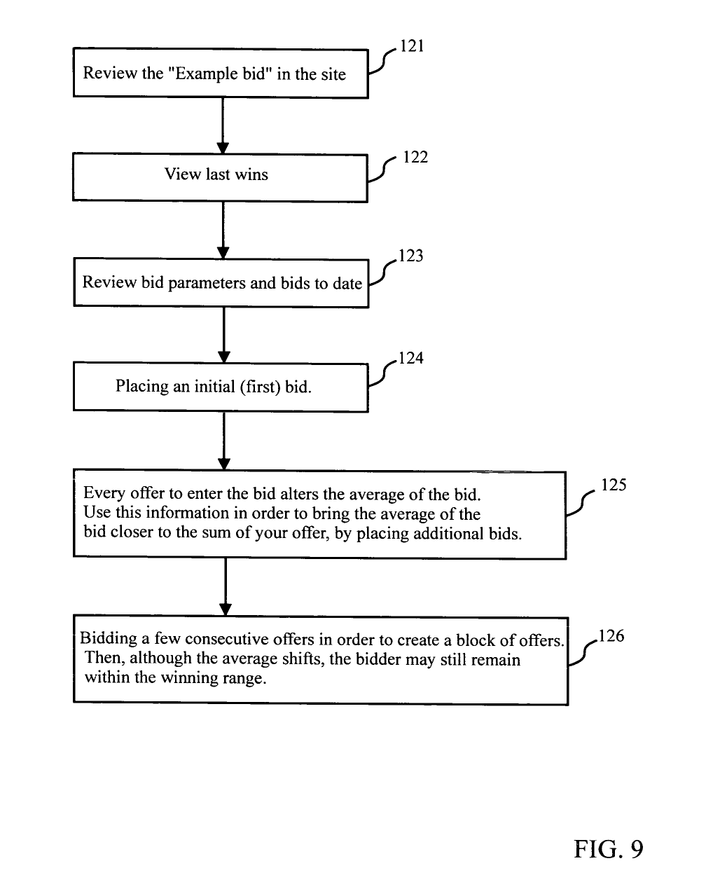

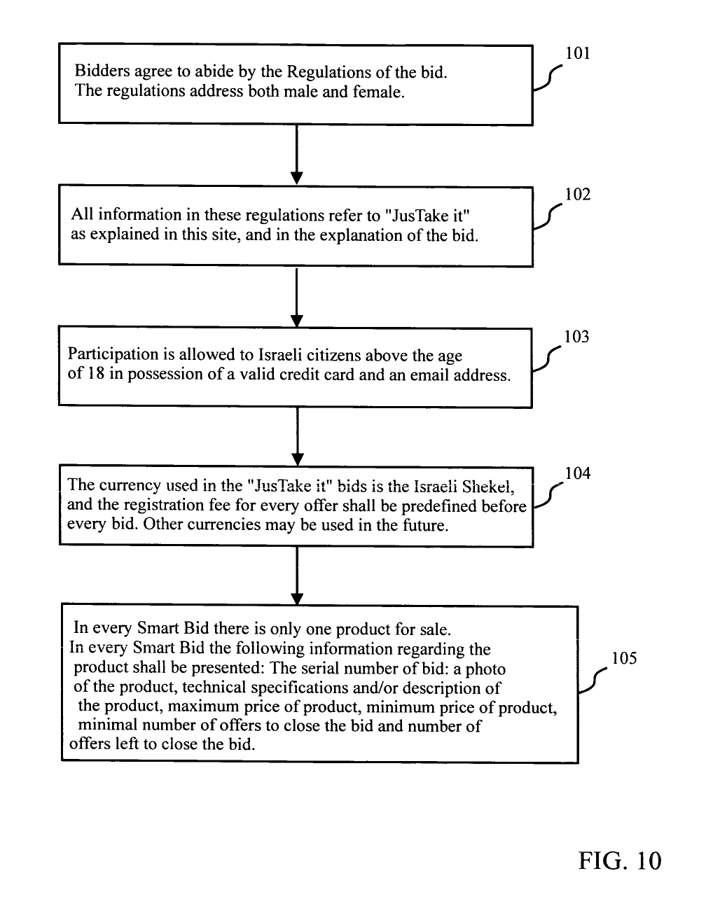

FIG. 9 details a method for interfacing with participants in the bid:

a. Review the “Example bid” in the site 121

b. View last wins. 122

c. Review bid parameters and bids to date 123

d. Placing an initial (first) bid. 124

e. Every offer to enter the bid alters the average of the bid. 125 Use this information in order to bring the average of the bid closer to the sum of your offer, by placing additional bids.

f. Bidding a few consecutive offers in order to create a block of 126 offers. Then, although the average shifts, the bidder may still remain within the winning range.

** End of method **

Method of Participation in the Bid

Proper use of the given data will give you the advantage of understanding how to buy products at half the market price and even less. Improving a bidder's chances to win:

a. If you have placed a bid, which is above\below a few places the average of the bid, you may place another higher\lower bid that shall raise\lower the average of the bid towards your offer.

b. In order to create an advantage over the other contestants, proper use of the given data will give you the advantage of understanding how to buy products at half the market price and even less.

c. In order to try at no charge, a participant may enter the “example bid”.

** End of method **

Method in Rules of the Bid

FIG. 10 details a method relating to the rules of the bid for participants, including:

a. Bidders agree to abide by the Regulations of the bid. 101 The Regulations address both male and female.

b. All information in these regulations refer to “JusTake it” 102 as explained in this site, and in the explanation of the bid.

c. Participation is allowed to Israeli citizens above the age 103 of 18 in possession of a valid credit card and an email address.

d. The currency used in the “JusTake it” bids is the Israeli shekel, 104 and the registration fee for every offer shall be predefined before every bid. Other currencies may be used in the future.

e. In every Smart Bid there is only one product for sale. 105 In every Smart Bid the following information regarding the product shall be presented: the serial number of bid: a photo of the product, technical specifications and\or description of the product, maximum price of product, minimum price of product, minimal number of offers to close the bid and number of offers left to close the bid.

The number of offers left to close the bid: Initially this number is set to be equal to the Minimal number of offers to close the bid; as bids are accepted, the number decreases until evenually it reaches zero, wherein the bid is automatically closed.

** End of method **

Additional details on Bid Regulations:

There is no limit on the number of bids made for one product presented in Smart Bid, however, every bidding offer shall be charged a participation fee at a sum decided in advance for that specific bid.

Every offer can be bid only once, therefore, if a participant bids an offer that has already been given, his offer shall not be accepted and the participant will not be charged the fee.

Minimum bidding sum—the system will not allow an offer lower than the minimum-bidding sum.

Maximum bidding sum—the system will not allow an offer higher than the maximum bidding sum.

Number of offers needed to close Smart Bid-Smart Bid will not close until the number of offers needed to close Smart Bid (as decided in advance) shall be filled.

Site manager may change the number of offers needed to close Smart Bid, as long as the number of offers to close the bid is not lower than 10% of the original sum of offers decided in advance.

Average bid- every Smart Bid will display an average indicator that shall calculate the average of all offers that have been bid.

The winning offer shall be the closest offer to the average indicator.

In case there are two offers equally close to the average indicator in the end of the bid, the winning offer shall be the one bid first.

Group Sale

A group sale is a sale that offers a group of buyers a set price for a product, on condition that there are a minimal number of buyers for the product.

As long as the group sale is open to offers, the site shall display the name of the participants in the sale. The first letter and full last name of the participants shall be displayed, as the cost of the product and date of the offer, which shall also be displayed.

You thereby agree to the displaying of these details on “JusTake it” in such a manner that they shall be visible to all Internet users.

“JusTake it” management may raise the number of items in the group sale as long as the number of items offered in advance has not been filled. Raising or lowering the amount of items shall not harm the chances of winning, for the participants whose offers have been accepted before hand.

If at the closing time of the group sale the number of orders is lower than the number of orders in the opening of the group sale, “JusTake it” management is allowed to approve or cancel the sale. If the sale has been canceled the participants shall not be charged a fee of any kind.

If the group sale has been approved then you have purchased the displayed product at the offered price, and you shall be considered in this agreement as the winning offer.

General Information

All products on sale at “JusTake it” are new and will be supplied in their original packaging including a service contract certificate.

Every bid shall display the number of business days needed in order to deliver the product to the winner (this does not include Friday, Saturday and holidays).

“JusTake it” management is responsible for the delivery arriving on time.

“hno trade & marketing Ltd.” company commits itself to maintaining complete secrecy regarding all information concerning participants, accepted in the system. “hno trade & marketing Ltd.” shall not make any use of this information beyond these bids and shall not hand the information over to a third party. This bid site is secured by the most secure electronic trade protocol—S.S.L.

If the “JusTake it” site management suspects that a participant is guilty of fraud, has misused a credit card and\or the participant has broken the regulation rules, the management may block this participants entrance to the bid at once.

In any case of dispute and\or lawsuit of a participant regarding the bid “hno trade & marketing Ltd.”, the prosecutor shall be limited to a refund of the participation fee and the sum of the claim up to maximum bid sum that is in controversy.

Partaking in bid offering in “JusTake it” bids is forbidden to any of the company owners, employees and their family members.

In case of a technical malfunction or malfunction due or problem beyond the management's control, the management may stop the bid as long as the participation fee is returned to the participants.

In order to participate in “JusTake it” bids, the participant must approve that he has read the instructions and regulations and that he agrees to all that is said and agrees to abide by them.

A message informing you winning the bid shall be sent shortly to your email as registered by you.

A list of offers that have been bid shall appear in a chart at the bottom of page of the bid. The chart shall specify: the name (in initials) of the participant offering the bid, placing in the bid, the offer which shall appear with a star—* and the date and time of offer.

After the bid has ended every participant who has given an offer will be able to view the other offers given throughout the bid.

All price offers given throughout the bid shall be saved in the system for seven days. At the end of these seven days the price offers shall be deleted from the system.

Customer service shall be available for participants through email or telephone.

Every customer shall receive email letters announcing new products, or receiving free offers or other messages.

Various embodiments of the present invention are possible. For example, rather than the average, a value related to the average may be taken, for example half the average, two thirds the average, etc.

The algebraic, rather than the arithmetic, average value may be used.

This is the Nth root of the product of N offers accepted. The product is the result of the multiplication of the values of these offers.

It will be recognized that the foregoing is but one example of a system and method within the scope of the present invention and that various modifications will occur to those skilled in the art upon reading the disclosure set forth hereinbefore.

1. A bidding method for buying products over the Internet comprising:
a. setting parameters for a bid;
b. opening the bid;
c. accepting offers in the bid, if the offers conform to predefined requirements and the parameters of the bid;
d. closing the bid according to predefined requirements and the parameters of the bid;
e. choosing a winner in the bid, if possible, according to the parameters of the bid.

2. The bidding method according to claim 1, wherein the chosen winner is the offer which is closest to an average value of all the accepted offers.

3. The bidding method according to claim 2, wherein the average value is computed as the sum of the amounts of all the accepted offers, divided by the number of the accepted offers.

4. The bidding method according to claim 2, wherein closeness to the average of an offer is the absolute value of the difference between an amount of that offer and the value of the average.

5. The bidding method according to claim 1, wherein the parameters of the bid include description of a product on sale, minimum and maximum sums, and a number of offers to close.

6. The bidding method according to claim 1 wherein, whilst the bid is open, presenting partial information to users.

7. The bidding method according to claim 6, wherein the partial information presented to users include information on all the offers accepted and their location relative to average, but without the amounts in other's offers.

8. The bidding method according to claim 6, wherein presenting to each user complete information on his offer or offers.

9. The bidding method according to claim 1 wherein, whilst the bid is open, accepting orders to change bid parameters from a site manager, checking each order according to predefined rules and, if an order is accepted, notifying participants in the bid of the new parameters.

10. The bidding method according to claim 1 wherein, after the bid is closed, presenting complete information to users.

11. The bidding method according to claim 10, wherein the complete information presented to users include all the accepted offers and their location relative to average, and to each participant the bid result: win or lose.

12. The bidding method according to claim 1, wherein an offer is accepted if its amount is different from previous accepted offers, and the amount is in the predefined minimum-maximum range.
